(19) United States
(12) Patent Application Publication
(10) Pub. No.: US 2022/0410287 A1
(43) Pub. Date: Dec. 29, 2022

(54) Interchangeable Drill Bit Holding Drill Head for Use with Powered Tools

(71) Applicant: Mike Evans, Nampa, ID (US)

(72) Inventor: Mike Evans, Nampa, ID (US)

(21) Appl. No.: 17/848,618

(22) Filed: Jun. 24, 2022

Related U.S. Application Data
(60) Provisional application No. 63/214,462, filed on Jun. 24, 2021.

(51) Int. Cl. B23B 51/12; B23B 31/02

(52) U.S. Cl. CPC B23B 51/12; B23B 31/02

(57) ABSTRACT

The present invention relates to a drill head design for powered tools. The drill head includes a coupling portion for securely and mechanically coupling to an air-powered tool, the coupling portion has a female port for receiving the gear drive from the air-powered tool. The drill head has a chuck portion that releasably holds a drill bit for performing assembling, drilling, cutting, and more without using large and bulky drills. The drill is releasably attached to the air-powered tool and comes in a variety of shapes and sizes. The drill head is configured to convert any air-powered tool into a drilling tool and enables the users to drill faster, accommodate smaller angles, and reach into confined spaces.

### CROSS-REFERENCE TO RELATED APPLICATION

The present application claims priority to, and the benefit of, U.S. Provisional Application No. 63/214,462, which was filed on Jun. 24, 2021 and is incorporated herein by reference in its entirety.

### FIELD OF THE INVENTION

The present invention relates generally to the field of air-powered tools, electric powered tools, and drilling devices. More specifically, the present invention relates to a novel drill head designed to attach to any air-powered tool easily and quickly, such as an air ratchet. The drill head enables users to use any air-powered tool for drilling while accommodating different drill bits for different purposes. The drill head comes in various designs to meet requirements and can be used for drilling hard-to-reach places and for accommodating smaller angles. Accordingly, the present disclosure makes specific reference thereto. Nonetheless, it is to be appreciated that aspects of the present invention are also equally applicable to other like applications, devices, and methods of manufacture.

### BACKGROUND

By way of background, a pneumatic tool, air tool, air-powered tool, impact wrench, or pneumatic-powered tool is a type of power tool driven by compressed air which is supplied by an air compressor, rather than electricity. Pneumatic tools are used for performing a wide variety of tasks and the strength of the air compressor is based on the task required to be performed using the tool. Pneumatic tools and impact wrenches have advantages such as, being safe, powerful, and lighter in weight; all while delivering tremendous amounts of torque and consistent power. Electric power tools are types of power tools driven by electricity which is supplied by electrical cord/outlet or rechargeable battery.

A common problem faced by operators of the pneumatic tools is that the pneumatic tools are not always compatible with drill heads. Therefore, operators are required to buy a specific pneumatic drill, as the conventional air tools like air ratchets cannot be used with drill heads. This is not only expensive, but individuals need to carry a dedicated drilling device which is cumbersome and laborious. Individuals desire a drill attachment that can quickly and easily attach to any air-powered tool.

In many cases, a pneumatic tool is compatible with a drill head but is not compatible with a drill bit that an operator may want to operate. Incompatibility with drill bits does not allow users to use pneumatic tools with drill heads and thus delays the process. Individuals desire a drill attachment that can accommodate different drills.

Conventional pneumatic drills have a bulky shaft that is short in length as well. Operators trying to perform drilling in narrow and hard-to-reach areas find it difficult to drill using pneumatic drills. Therefore, individuals desire a drill attachment that can be used for drilling in hard-to-reach places and in confined angles.

Therefore, there exists a long-felt need in the art for an improved drill head that can be attached to any air-powered tool. There is also a long-felt need in the art for a drill head that can convert any pneumatic tool to a drilling device. Additionally, there is a long-felt need in the art for a drill head that can accommodate different drill bits. Moreover, there is a long-felt need in the art for a drill head that is easily attached to and removed from an air tool. Further, there is a long-felt need in the art for a drill head design that can be used as an alternative to larger bulky drills for more fine-tuned use. Furthermore, there is a long-felt need in the art for an improved drill head that can be rotated at any speed using drive gear of the air-powered tool. Finally, there is a long-felt need in the art for a drill head that is compatible with air-powered tools and can be used for drilling in hard-to-reach areas easily.

The subject matter disclosed and claimed herein, in one embodiment thereof, comprises an air-powered tool drill head. The air-powered tool drill head is configured to be removably attached to an air-powered tool and offers an alternative to larger bulky drills for more fine-tuned use. The drill head further comprises a chuck portion having a jaw for removably accommodating a drill bit, a coupling portion for coupling to the air-powered tool, the coupling portion having a female port configured to couple to a male coupler of the air-powered tool for receiving drive gear from the air-powered tool. The drill head is configured to convert any air-powered tool into a drilling tool and can be used for faster drilling, and for accommodating smaller confined angles.

In this manner, the drill head design of the present invention accomplishes all of the foregoing objectives and provides users with an improved drill design that allows the user to drill faster and to accommodate smaller angles using any air-powered tool. The head comes in different designs and can be attached to air-powered tools for receiving rotation motion from drive gear of the air-powered tool to which the drill head is attached.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an air-powered tool drill head. The air-powered tool drill head is configured to be removably attached to an air-powered tool and further comprises a chuck portion having a jaw for removably accommodating a drill bit, a coupling portion for coupling to the air-powered tool, the coupling portion having a female port configured to couple to a male coupler of the air-powered tool for receiving drive gear from the air-powered tool, wherein the received drive gear is configured to rotate the drill bit for performing drilling, assembling, and more.

In yet another embodiment, a detachable drill head for an air-powered tool is disclosed. The drill head comprising a coupling portion for securely coupling to an air-powered tool, the coupling portion including a plurality of locking pins and ribs for secure coupling and a female port for receiving drive force from the air-powered tool, a rotatable shaft for rotating using the received drive, wherein a drill bit attached to a chuck portion of the air-powered tool is rotated using the rotatable shaft.

In yet another embodiment, the female port is aligned to the male coupler of the air-powered tool.

In yet another embodiment, the female port receives the male coupler of the air-powered tool.

In yet another embodiment, the drill bit is removably attached to the drill head and can be replaced with a different drill bit.

In yet another embodiment, the drill head may have a square driver shape.

In yet another embodiment, the drill head can be removably attached to any air-powered tool.

In yet another embodiment, an air-powered tool with a detachable drill head is disclosed. The tool includes a male coupling portion configured to receive the drill head, the male coupling portion has a male coupler configured to couple to a female port of said detachable drill head for driving the drill head, the drill head having a chuck portion for removably receiving a drill bit, wherein the drill bit receives drive force from the male coupler of the air-powered tool.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a novel drill head of the present invention in accordance with the disclosed architecture;

FIG. 2 illustrates an enlarged view of the coupling portion of the drill head for coupling to an air-powered tool in accordance with the disclosed architecture;

FIG. 3 illustrates an enlarged view of an exemplary coupling portion of a conventional air-powered tool to which the drill head of the present invention can be attached for use in accordance with the disclosed architecture;

FIG. 4A illustrates a perspective view showing another embodiment of the drill head of the present invention in accordance with the disclosed architecture;

FIG. 4B illustrates a perspective view showing yet another embodiment of the drill head of the present invention in accordance with the disclosed architecture; and

FIG. 5 illustrates a perspective view of the drill head attached to an air ratchet and used for drilling in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved drill head that can be attached to any air-powered tool. There is also a long-felt need in the art for a drill head that can convert any pneumatic tool to a drilling device. Additionally, there is a long-felt need in the art for a drill head that can accommodate different drill bits. Moreover, there is a long-felt need in the art for a drill head that is easily attached to and removed from an air tool. Further, there is a long-felt need in the art for a drill head design that can be used as an alternative to larger bulky drills for more fine-tuned use. Furthermore, there is a long-felt need in the art for an improved drill head that can be rotated at any speed using drive gear of the air-powered tool. Finally, there is a long-felt need in the art for a drill head that is compatible with air-powered tools and can be used for drilling in hard-to-reach areas easily.

The present invention, in one exemplary embodiment, is a novel detachable drill head for an air-powered tool. The drill head comprising a coupling portion for securely coupling to an air-powered tool, the coupling portion including a plurality of locking pins and ribs for secure coupling and a female port for receiving drive from the air-powered tool, a rotatable shaft for rotating using the received drive force, wherein a drill bit attached to a chuck portion of the air-powered tool is rotated using the rotatable shaft. The drill head comes in different shapes and sizes and can be attached to any air-powered tool.

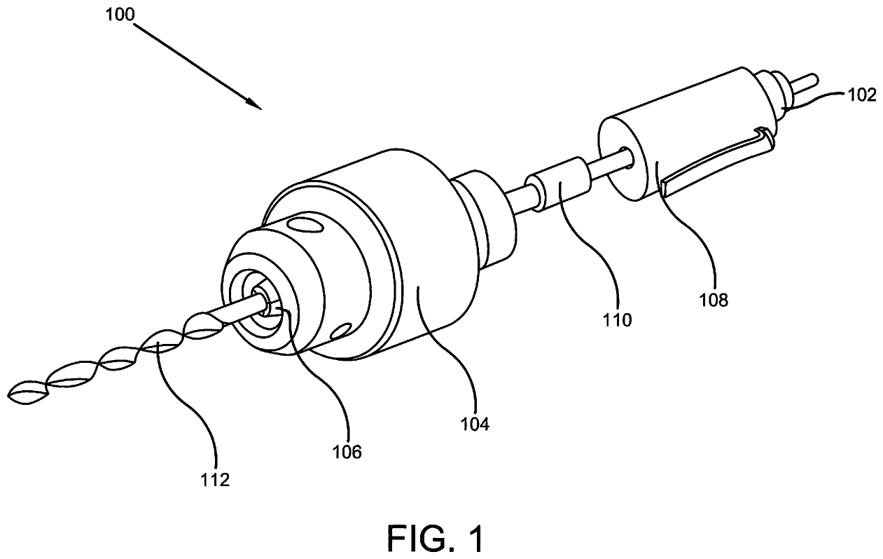

Referring initially to the drawings, FIG. 1 illustrates a perspective view of one potential embodiment of the novel drill head 100 of the present invention in accordance with the disclosed architecture. The drill head 100 is configured to attach to any air-powered tool easily and quickly for enabling fast and easy drilling. Further, the drill head 100 is configured to accommodate different drill bits that are interchangeably attached to the drill head 100 allowing users to perform a well-balanced drill in hard-to-reach and/or confined areas.

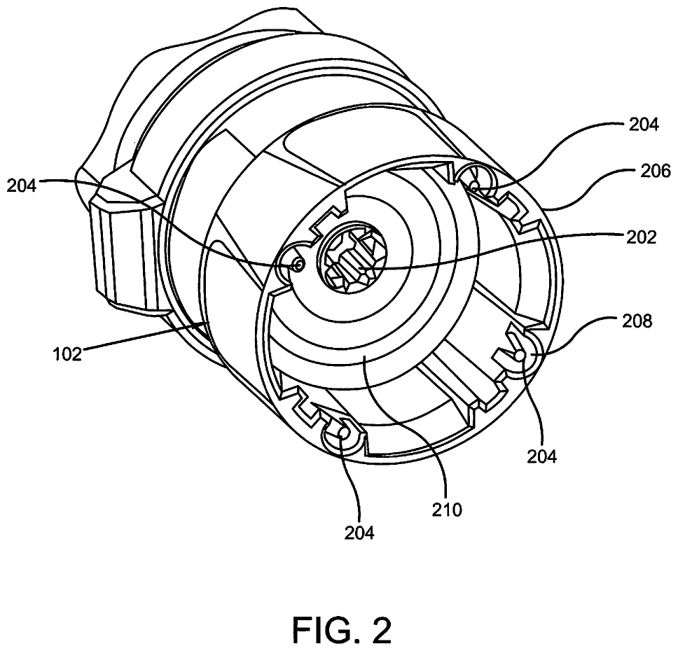

More specifically, the drill head 100 is a compact tool for manipulation in small spaces and can be easily operated using any conventional air-powered tool. The drill head 100 has a coupling portion 102 for coupling to an air-powered tool and for receiving power from drive gear of the air-powered tool like air ratchet. The coupling portion 102 has an inner surface having a plurality of grooves disposed thereon (shown in FIG. 2) that helps in coupling the drill head 100 to the air-powered tool. A drill chuck 104 is positioned at one end of the coupling portion 102 and includes jaws 106 for holding a drill bit 112 or any other cutting instrument. The jaws 106 can secure drill bits 112, drive bits, and/or die grinder mounting bits having round shanks or hex sided shanks. The chuck 104 is connected to the drill head housing 108 wherein the housing 108 rotatably drives using the gear drive of the air-powered tool to which the drill head 100 is mounted. The rotating portion 110 of the drill head 100 is configured to rotate using the drive of the air-powered tool to which the coupling portion 102 is removably attached.

FIG. 2 illustrates an enlarged view of the coupling portion 102 of the drill head 100 for coupling to an air-powered tool in accordance with the disclosed architecture. As illustrated, the coupling portion 102 has a female port 202 which engages to a male port of the air-powered tool. The female port 202 is aligned with the male port when the drill head is coupled to the air-powered tool in order to transfer drive force or power from the motor of the air-powered tool to the drill head 100 and to the output of the drill head 100.

A plurality of locking pins 204 are positioned on the coupling portion 102 for locking the drill head 100 to the air-powered device. A base plate 206 helps in abutting the drill head 100 to the air-powered tool and helps in secure positioning of the head 100. A plurality of recesses 208 and ribs 210 also help in secure coupling and positioning of the head on the air-powered tool.

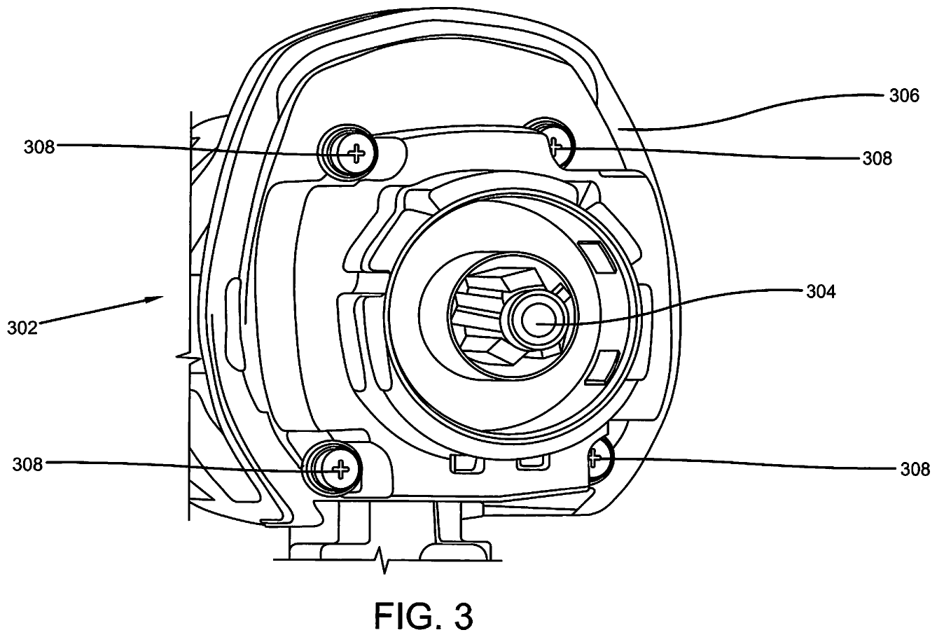

FIG. 3 illustrates an enlarged view of an exemplary coupling portion of a conventional air-powered tool to which the drill head of the present invention can be attached for use in accordance with the disclosed architecture. The coupling portion 302 of an air-powered tool has a male coupler or port 304 which is aligned with the female port 202 of the head 100 of the present invention for transferring power to the head 100. While the exemplary embodiments show that the air-powered tool has a male coupler 304 and the drill head has female coupler 202, it is to be appreciated that these could be reversed. The plate 206 of the head 100 abuts to the front face 306 of the coupling portion 302 thereby aligning the male coupler or port 304 and the female port 202. A plurality of grooves 308 are positioned in the coupling portion 302 allowing the locking pins 204 of the head 100 to lock with the air-powered tool. The female port 202 includes a graduated female coupler that decreases in diameter from a first diameter of ¾″, to a second diameter of ½″, and finally to a third diameter of ¼″ for selectively receiving respective sized ratchet male drive heads.

The locking pin receivers 308 are used to receive the locking pins of the drill head 100 and are used for secure coupling. It should be appreciated that the base plate 206 of the head 100 and the front face 306 of the coupling portion 302 can be magnetic, thereby obviating the need for screws to attach the drill head to the air-powered tool.

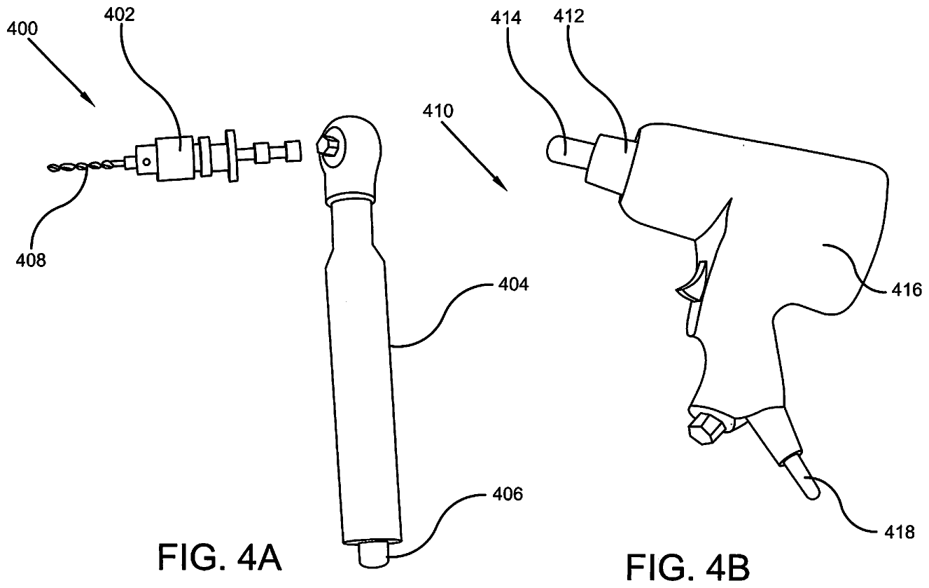

FIG. 4A illustrates a perspective view showing another embodiment of the drill head of the present invention in accordance with the disclosed architecture. In the present embodiment, the drill head attachment 400 is designed to allow drilling in smaller areas, confined angles and narrow spaces. More specifically, the drill head 400 has a chuck component 402 and a longitudinal handle 404 positioned perpendicular to the chuck component 402. The coupling portion 406 is used for attaching the drill head 400 to any air-powered tool. Further, the drill bit 408 is detachable and can be interchanged with any bit of different design and size.

FIG. 4B illustrates a perspective view showing yet another embodiment of the drill head of the present invention in accordance with the disclosed architecture. In the present embodiment, the drill head attachment 410 is designed to attach drill bits of higher strength. The attachment 410 includes a chuck component 412 attached to a drill bit jaw 414. The rotating component of the attachment 410 is positioned inside the housing 416 at one end and a coupling portion 418 is positioned on an opposing end for securing the attachment 410 to any air-powered tool.

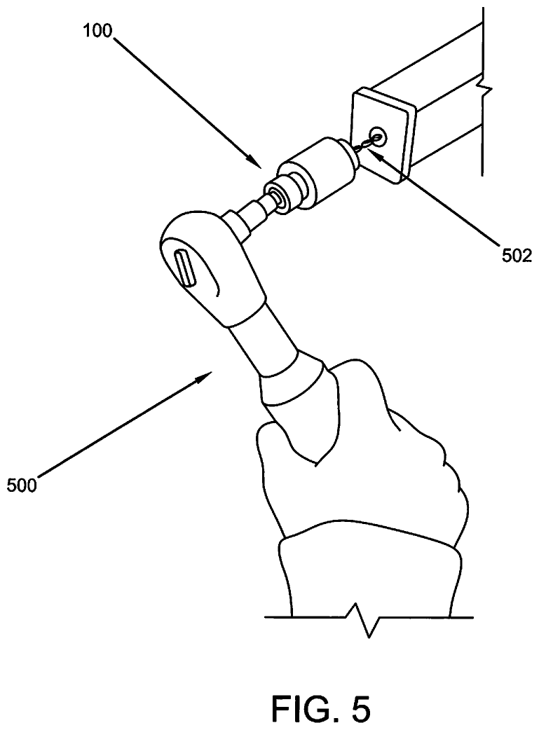

FIG. 5 illustrates a perspective view of the drill head 100 attached to an air ratchet and used for drilling in accordance with the disclosed architecture. The drill head 100 is coupled to an air-powered tool, such as an air ratchet 500, using the coupling portion having the female port of the drill head. Once the drill head 100 is securely coupled, then, a desired drill bit 502 is attached to the chuck portion 104 and next, using the gear drive of the air ratchet 500, the drill bit 502 is rotated to perform drilling, assembling, or any other desired task.

Other shapes, designs, and configurations of the drill head attachment 100 are contemplated and fall within the scope of the invention without affecting the utility of the device.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “drill head”, “drill head design”, “detachable drill head”, and “air-powered tools drill head attachment” are interchangeable and refer to the air-powered tools drill head attachment 100, 400, 410 of the present invention.

Notwithstanding the foregoing, the air-powered tools drill head attachment 100, 400, 410 of the present invention can be of any suitable size and configuration as is known in the art without affecting the overall concept of the invention, provided that it accomplishes the above-stated objectives. One of ordinary skill in the art will appreciate that the air-powered tools drill head attachment 100, 400, 410 as shown in the FIGS. are for illustrative purposes only, and that many other sizes and shapes of the air-powered tools drill head attachment 100, 400, 410 are well within the scope of the present disclosure. Although the dimensions of the air-powered tools drill head attachment 100, 400, 410 are important design parameters for user convenience, the air-powered tools drill head attachment 100, 400, 410 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drill head for interchangeably mounting drill bits, the drill head comprising:
a drill head coupling portion for coupling to an air-powered tool and for receiving power from a drive gear of said air-powered tool;
a drill chuck positioned at one end of said drill head coupling portion having a plurality of jaws for holding a drill bit;
a rotating portion of the drill head configured to rotate using the drive of said air-powered tool to which said drill head coupling portion is removably attached;
wherein said drill head coupling portion includes an inner surface having a plurality of grooves disposed thereon for coupling the drill head to said air-powered tool;
wherein said drill chuck is connected to rotating arms of a drill head housing;
wherein said drill head housing rotatably drives using a gear drive of said air-powered tool to which the drill head is mounted;
wherein said drill head coupling portion having a female port for coupling to a male port of said air-powered tool;
wherein said female port aligned with said male port when the drill head is coupled to said air-powered tool to transfer drive force from a motor of said air-powered tool to the drill head;
a plurality of locking pins positioned on said drill head coupling portion for locking the drill head to said air-powered tool;
a base plate abuts said drill head coupling portion to said air-powered tool to secure positioning of the drill head; and
a plurality of recesses and ribs positioned on said drill head coupling portion for securing the drill head to said air-powered tool.

2. The drill head of claim 1, wherein said base plate and a front face of said air-powered tool are magnetic.

3. The drill head of claim 1, wherein said air-powered tool having an air-powered tool coupling portion aligning said male port with said female port of said drill head coupling portion.

4. The drill head of claim 3, wherein said base plate abuts to a front face of said air-powered tool coupling portion.

5. The drill head of claim 4, wherein said air-powered tool coupling portion having a plurality of locking pin receivers positioned for receiving said plurality of locking pins.

6. The drill head of claim 5, wherein said drill chuck is aligned with said air-powered tool.

7. The drill head of claim 1, wherein said air-powered tool is an air ratchet.

8. A drill head for interchangeably mounting drill bits, the drill head comprising:
a drill head coupling portion for coupling to an air-powered tool and for receiving power from a drive gear of said air-powered tool;
a drill chuck positioned at one end of said drill head coupling portion having a plurality of jaws for holding a drill bit;
wherein said drill chuck perpendicular to said air-powered tool;
a rotating portion of the drill head configured to rotate using the drive of said air-powered tool to which said drill head coupling portion is removably attached;
wherein said drill head coupling portion includes an inner surface having a plurality of grooves disposed thereon for coupling the drill head to said air-powered tool;
wherein said drill chuck is connected to rotating arms of a drill head housing;
wherein said drill head housing rotatably drives using a gear drive of said air-powered tool to which the drill head is mounted;
wherein said drill head coupling portion having a female port for coupling to a male port of said air-powered tool;
wherein said female port aligned with said male port when said drill head is coupled to said air-powered tool to transfer drive force from a motor of said air-powered tool to the drill head;
a plurality of locking pins positioned on said drill head coupling portion for locking the drill head to said air-powered tool;
a base plate abuts said drill head coupling portion to said air-powered tool to secure positioning of the drill head; and
a plurality of recesses and ribs positioned on said drill head coupling portion for securing the drill head to said air-powered tool.

9. The drill head of claim 8, wherein said base plate and a front face of said air-powered tool are magnetic.

10. The drill head of claim 8, wherein said air-powered tool having an air-powered tool coupling portion aligning said male port with said female port of said drill head coupling portion.

11. The drill head of claim 10, wherein said base plate abuts to a front face of said air-powered tool coupling portion.

12. The drill head of claim 11, wherein said air-powered tool coupling portion having a plurality of locking pin receivers positioned for receiving said plurality of locking pins.

13. The drill head of claim 8, wherein said air-powered tool is an air ratchet.

14. A drill head for interchangeably mounting drill bits, the drill head comprising:
a drill head coupling portion for coupling to a powered ratchet tool and for receiving power from a drive gear of said powered ratchet tool;
a drill chuck positioned at one end of said drill head coupling portion having a plurality of jaws for holding a drill bit;
a rotating portion of the drill head configured to rotate using the drive of said powered ratchet tool to which said drill head coupling portion is removably attached;
wherein said drill head coupling portion includes an inner surface having a plurality of grooves disposed thereon for coupling the drill head to said powered ratchet tool;
wherein said drill chuck is connected to rotating arms of a drill head housing;
wherein said drill head housing rotatably drives using a gear drive of said powered ratchet tool to which the drill head is mounted;
wherein said drill head coupling portion having a female port for coupling to a male port of said powered ratchet tool;
wherein said female port aligned with said male port when the drill head is coupled to said powered ratchet tool to transfer drive force from a motor of said powered ratchet tool to the drill head;
a plurality of locking pins positioned on said drill head coupling portion for locking the drill head to said powered ratchet tool;
a base plate abuts said drill head coupling portion to said powered ratchet tool to secure positioning of the drill head; and
a plurality of recesses and ribs positioned on said drill head coupling portion for securing the drill head to said powered ratchet tool.

15. The drill head of claim 14, wherein said female port comprises a graduated female coupler that decreases in diameter from a first diameter of ¾″, to a second diameter of ½″, and finally to a third diameter of ¼″ for selectively receiving respective sized said male ports of said powered ratchet tool.

16. The drill head of claim 14, wherein said powered ratchet tool is an air ratchet tool having a coupling portion aligning said male port with said female port of said drill head coupling portion.

17. The drill head of claim 16, wherein said base plate abuts to a front face of said air ratchet tool coupling portion.

18. The drill head of claim 17, wherein said air ratchet tool coupling portion having a plurality of locking pin receivers positioned for receiving said plurality of locking pins.

19. The drill head of claim 18, wherein said drill chuck is aligned with said air ratchet tool.

20. The drill head of claim 18, wherein said drill chuck perpendicular to said air ratchet tool.
